(19) United States
(12) Patent Application Publication
(10) Pub. No.: US 2017/0155583 A1
(43) Pub. Date: Jun. 1, 2017

(54) DIGITAL FRAME SWITCH

(71) Applicant: Paul Ortais, Paris (FR)

(72) Inventor: Paul Ortais, Paris (FR)

(21) Appl. No.: 15/312,781

(22) PCT Filed: May 19, 2015
(86) PCT No.: PCT/FR2015/051299

§ 371 Date: Nov. 21, 2016

(30) Foreign Application Priority Data
May 21, 2014 (FR) 1454573

(51) Int. Cl. H04L 12/741; H04L 12/935; H04L 12/863

(52) U.S. Cl. CPC H04L 45/745; H04L 47/62; H04L 49/3027; H04L 47/627

(57) ABSTRACT

This disclosure relates to a switch for digital frames exchanged with an external computer system, the switch comprising at least one input port, at least one output port and a switching matrix, the input port also comprising: a first means for validating the incoming frame, a second means for routing the validated frame, a third means for temporarily storing the validated incoming frame; the means for temporarily storing the validated incoming frame being controlled by “flow control” information from the switching matrix; the output port including: a means for temporarily storing the outgoing frame controlled by “flow control” information from the external computer system, the digital-frame switching operation in FIFO (first in, first out) mode.

### CROSS-REFERENCE TO RELATED APPLICATIONS

This application is a national phase entry under 35 U.S.C. §371 of International Patent Application PCT/FR2015/051299, filed May 19, 2015, designating the United States of America and published as International Patent Publication WO 2015/177452 A1 on Nov. 26, 2015, which claims the benefit under Article 8 of the Patent Cooperation Treaty to French Patent Application Serial No. 1454573, filed May 21, 2014.

### TECHNICAL FIELD

This application relates to the field of digital control systems intended, in particular, for embedded equipment such as industrial, aeronautical, automobile, rail or ship equipment.

### BACKGROUND

The general principle of such systems is well known: they are, for example, switched Ethernet networks. Ethernet is a local packet switching network protocol. Although it implements the physical layer (PHY) and the media access control (MAC) sublayer of the IEEE 802.3 model, the Ethernet protocol is classed in data and physical connection layers, since the 802.2 LLC (logical link control) layer forms the hinge between the top layers and the MAC (media access control) sublayer that forms an integral part of the 802.3 process with the physical layer, since the frame formats that the standard defines are standardized and can be encapsulated in protocols other than its own MAC and PHY physical layers. These physical layers are the subject of separate standards according to the transmission rates, the transmission carrier, the length of the connections and the environmental conditions.

The Ethernet is based on the principle of members (pairs) on the network, sending messages in what was essentially a radio system, captive in a wire or a common channel, sometimes referred to as the ether. Each pair is identified by a globally unique key, referred to as the MAC address, in order to ensure that all the stations on the Ethernet network have separate addresses.

In aeronautics, the AFDX bus is known, based on the routing of Ethernet frames by means of central switches referred to as hubs, reducing the problem of indeterminism relating to conflict in physical access to the medium.

Solutions used in the space industry are also known by the term “Spacewire,” a computer bus based historically on the IEEE 1355 standard and specified in the form of a European standard (ECSS-E-ST-50-12C).

In the automobile field, the prior art comprises CAN technology. The CAN (controller area network) bus is a serial system bus very widespread in many industries, in particular, the automobile industry. CAN is based entirely on CSMA, with arbitration of collisions at the “CSMA/BA” bit. It was standardized with ISO 11898.

It applies, like those cited previously, to an approach known by the term multiplexing, which consists of connecting a plurality of computers to the same cable (a bus) that, therefore, communicate in turn. This technique eliminates the need to cable dedicated lines for each item of information to be passed (point-to-point connection). As soon as a system (car, aircraft, telephone network, etc.) reaches a certain level of complexity, the point-to-point approach becomes impossible because of the immense quantity of cabling to be installed and the cost thereof (in terms of weight, materials, labor, maintenance).

The purpose of introducing multiplexed buses (mainly CAN) into automobiles was to reduce the quantity of cables in the vehicles (there are up to 3 km of cable per car), but it, in particular, allowed an explosion in the number of computers and sensors distributed throughout the vehicle, and corresponding services (reduction in consumption, depollution, active/passive safety, comfort, detection of faults, etc.), while not excessively increasing the cabled lengths.

For the automobile industry, the Ethernet or AFDX solution is not suitable since it is too complex and, therefore, expensive and lacking reactivity. In particular, the frames are bulky and not very reactive since they are designed to follow a complex routing, with collisions for Ethernet or routers for AFDX. The result is also control components that are complex and, therefore, expensive.

The “CAN bus” solution is economical but has the drawback of lack of software robustness and mediocre performance, not allowing efficient use in a system of embedded computers.

The Spacewire solution is efficient and potentially economical with regard to the components, but has the drawback of a lack of flexibility, in particular, for implementing complex systems, the cost advantage becoming debatable on the system scale.

Prior Art

The closest prior art is taught by U.S. Patent Publication No. 2010/0061241 by Sindhu et al. (“Sindhu”), which proposes a switching solution comprising a multiple-stage switching matrix comprising a plurality of input buffers and a plurality of output ports, configured so as to be coupled to a plurality of embedded devices. This controller is controlled by software during configuration and monitoring, to send a flow control signal to an input buffer from the plurality of input buffers when congestion occurs at an output port.

The Sindhu disclosure describes a mechanism making it possible to suspend the propagation of a queue of frames in order to allow another queue to pass, which obviously leads to a reversal of the temporal order of receiving these various frames.

In particular, the concept of “frame” is mentioned in the Sindhu disclosure only in paragraph [0028] in order to specify the transmission speed of the queues consisting of a plurality of frames between which the time spacing is not defined. This paragraph states, in particular, that the “suspension of the transmission” may be indefinite, which implies that a queue (and the set of frames that it contains) may never be transmitted by the switch proposed in the prior art.

U. S. Patent Publication No. 2005/0047334 by Paul et al. (“Paul”) is also known, and the Paul disclosure describes a switch of the fiber channel type that makes it possible to monitor the state of congestion of the destination ports in an XOFF mask at each input.

Mapping allows changes in the XOFF mask in order to trigger a primitive at an upstream port that provides a virtual channel flow control.

The XOFF mask is also used to prevent the sending of frames to a congested port.

Instead of this, these images are stored on a single deferred queue and then processed in a way designed to maintain frame control.

A routing system applies various routing rules in parallel in order to effect routing of the line speed.

The preferred switching matrix is based on the cell, with the techniques used for managing the maintenance of the pathway for frames of variable length and to adapt to various transmission rates in the system.

Drawbacks of the Prior Art

The solutions proposed in the prior art have a major drawback, since they do not guarantee the temporal order of sending of the frames and conformity to the temporal order of reception of these frames.

However, the applications, in the Ethernet context, optionally allow a reversal of alternation of the sequencing of the frames; however, many applications in the internet context impose strict compliance with the temporal sequencing of the frames. However, in all cases, when the temporal sequencing of the frames is not guaranteed by the network, it is necessary to provide supplementary solutions for restoring upstream the temporal sequencing of the frames. This introduces three consequences:
it is necessary to provide often major additional hardware and software resources (it is a question of the “communication stack”);
this introduces an additional risk resulting from this complexity of hardware and computing means; and
this introduces prejudicial processing times and delays in real-time applications.

### BRIEF SUMMARY

An objective of embodiments described in this disclosure is to remedy these drawbacks by proposing a robust, flexible and efficient universal solution.

To this end, the disclosure relates more particularly, in accordance with its most general acceptance, to a switch for digital frames exchanged with an external computer system, the switch comprising at least one input port, at least one output port and a switching matrix, wherein the input port further comprises:
a first means for validating the incoming frame,
a second means for routing the validated frame,
a third means for temporary storage of the validated incoming frame,
the means for temporary storage of the validated incoming frame being controlled by information of the “flow control” type coming from the switching matrix,

and in that the output port comprises:
a means for temporary storage of the outgoing frame controlled by information of the “flow control” type coming from the external computer system,

the digital-frame switch functioning according to a FIFO (first in first out) mode, which assumes not granting priority to some frames as with Ethernet and AFDX.

“Digital frame,” within the meaning of this disclosure, means a packet of in-dissociable data commencing with a start-of-frame marker or header, digital data and an end-of-frame marker also serving to verify the integrity of the frame. The length of the frame is not necessarily fixed, but may be specified in the header in order to facilitate identification of the position of the end-of-frame marker.

A set of frames constitutes a message, transported in the form of a queue in which the order of the frames may be disturbed without drawback in the Ethernet context, and in which the temporal spacing of the following frames has only secondary importance; a message may remain waiting, awaiting the arrival of all its frames.

In the context of hard real time, which is more specifically that of the disclosure, it happens that the order of the frames and the temporal spacing is critical and non-modifiable.

Preferably, the digital-frame switch according to the disclosure propagates them while preserving their temporal integrity, in addition to their logical integrity, which goes without saying in the prior art.

According to a first embodiment, at least one of the incoming ports and/or at least one of the outgoing ports is associated with a physical network interface.

According to a second embodiment, at least one of the incoming ports and/or at least one of the outgoing ports is connected to a local computer.

Advantageously, it comprises a plurality of computers.

According to an example embodiment, at least one of the ports comprises a serial physical interface.

According to another example embodiment, at least one of the ports comprises a parallel physical interface.

According to another example, the switch comprises a single incoming port and a single outgoing port forming a bidirectional communication channel.

According to an advantageous embodiment, the switch according to the disclosure further comprises a memory for recording a digital file describing:
frame validation rules, and
routing rules applicable to each frame.

The disclosure also relates to a system comprising a plurality of switches according to at least one of the previous solutions, and a memory distributed over all the switches for recording frame validation rules and routing rules that can be applied to each frame by each switch.

### BRIEF DESCRIPTION OF THE DRAWINGS

The disclosure will be better understood from a reading of the description of a non-limitative example that follows, referring to the accompanying drawings, where:

FIG. 1 shows an outline diagram of a circuit using switches according to the disclosure;

FIG. 2 shows a schematic view of a frame switch;

FIG. 3 shows a schematic view of the data frame;

FIG. 4 shows a schematic view of the architecture of a component according to the disclosure;

FIG. 5 shows a schematic view of the outgoing frame;

FIG. 6 shows a schematic view of the output port;

FIG. 7 shows a schematic view of an application of a network interface;

FIG. 8 shows a schematic view of a network gateway application;

FIG. 9 shows a schematic view of another network gateway application;

FIG. 10 shows a schematic view of a multiprocessor application;

FIG. 11 shows a schematic view of a heterogeneous architecture;

FIG. 12 illustrates in solid lines a system with a single switch connection according to the disclosure (connection 1202 in a broken line);

FIG. 13 illustrates an example of a frame structure; and

FIG. 14 illustrates the model of the communication step.

### DETAILED DESCRIPTION

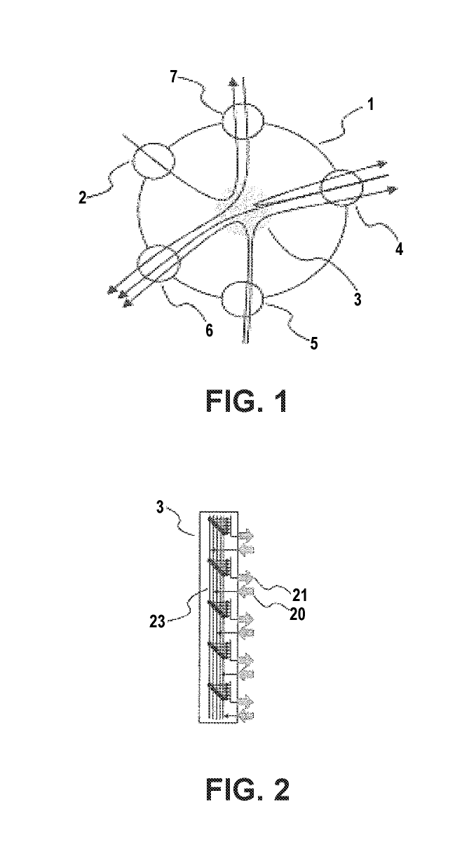

FIG. 1 shows an example of use of a digital switch according to the disclosure.

This digital-frame switch (1) according to the disclosure is composed of communication ports (2, 4, 5, 6, 7) connected by a switching matrix (3).

The input ports (2, 5) receive digital frames from the external environment. The output ports (6) send to the outside frames that are routed to them by the switching matrix (3). The input and output ports may be associated in order to form input/output ports (4, 7).

FIG. 7 shows a schematic view of a frame switch comprising:
at least one input port (71),
the switching matrix (72), and
at least one output port (73).

The input port (71) comprises a physical interface (41), for example, a deserializer, for interconnection with a network or a parallel port for interconnection with an adjacent computer.

The port also comprises an electronic circuit (42) carrying out an integrity check on the frame, for example, by checks of the checksum or CRC (cyclic redundancy check) type, by parity test or error detection, or by a method of the EDAC “error detection and correction” type.

By way of non-limitative example, such a means is described in European patent EP 2437172. Patent EP 2437172 describes an error detection and correction (EDAC) circuit for use in a redundant storage system, the EDAC circuit comprising:
a first input for receiving first data and parity information stored by a first storage device;
a second input for receiving second data and parity information stored by a second storage device; and
a first output for supplying the first data or the second data on a data bus.

A first parity check logic calculates whether the parity is “good” or “bad” in the first data and parity information received. A second parity check logic calculates whether the parity is “good” or “bad” in the second data and parity information received. Binary comparison logic detects differences between the first data and the second data. The binary comparison logic detects differences between the first parity information and the second parity information.

Data selection logic chooses the first data or the second data in order to supply at the first output, on the basis of the parity calculated, first data and second data as well as differences between the first data and the second data, and between the first parity information and the second parity information. Single-bit or multiple-bit error detection logic detects the presence of multiple-bit errors in the first and second data and parity information on the basis of the differences detected between the first data and the second data and between the first parity information and the second parity information. Single-bit or multiple-bit error logic resets the storage system in response to multiple-bit errors detected, in which the behavior of the EDAC circuit is defined by a logic table.

This circuit (42) performs either the error correction, the frame identification or the extraction of the frame identification or the extraction of the frame identifier, for example, the first series of information contained in the frame.

This input-frame identification data is used as an input of an associative memory in which a lookup table is recorded, associating a routing vector with each input, for example in the form of an N-bit word (N corresponding to the number of output ports). If all the bits are at the “true” state, the frame will be broadcast to all the output ports.

The routing (44) consists of associating this routing vector with the validated input frame. The result of this processing is recorded in a memory (45) of the fall-through FIFO (first in, first out) type. Storage occurs only if the output does not make it possible to immediately propagate the outgoing frame, especially if the output port is not free or if all the output ports designated by the routing vector are not in a position to simultaneously and immediately provide propagation.

The output port (73) also comprises a temporary FIFO storage memory (61), providing storage only when propagation is not immediately possible.

It also comprises a serial or parallel physical interface (62).

A matrix (72) consists of a set of multiplexers arranged in a complete graph of the full-mesh type. It provides distribution of the validated input frames to the output port according to the routing vectors associated by the routing (44). The matrix (72) is passed through when an input frame is to be routed to a FIFO memory (61) available on the corresponding output port (73).

The switching matrix (72) receives digital frames from the input ports on its inputs (20) and directs them to one or more of its outputs (21) to the corresponding output ports (see FIG. 2). One advantageous embodiment is to associate, with each output (21) of the switching matrix (72), a multiplexer receiving all the inputs of the switching matrix (72).

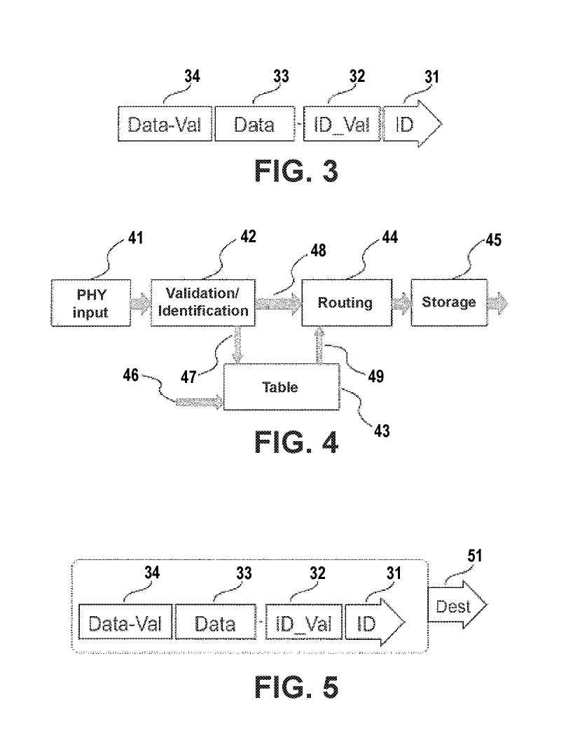

FIG. 3 shows an example of the structure of a digital frame.

The incoming frame begins with an identification key ID (31) by means of which the frame switch identifies the routing that will be applied to it.

The frame identifier (31) is immediately followed by check data ID_Val (32) and these two associated items of information prove the integrity of the ID (31) and enable decoding thereof.

The payload (33) of the digital frame follows, and may also be accompanied by an integrity check key Data_Val (34).

The input port (2, 5; see FIG. 1) comprises the elements described in FIG. 4.

The digital frames coming from the outside world through a physical interface (41) converting the physical format of the digital frame dependent on the medium used, into a format suited to the internal digital propagation by FIFO.

A first validation (42) checks the integrity of the pair {ID (31): ID_Val (32)} in order to accept/reject it (see FIG. 3).

The identifier ID (31) of the accepted frame is passed (operation 47) to the routing table (43) associated with the input port. The routing (44) assigns to the incoming frame (received in operation 48) the routing (received in operation 49) recorded in the table (43).

The table (43) also has logic inputs (46), also referred to as flags, indicating the state of the network in the vicinity of the switch and uses this information to select, from the routes recorded for a frame, the one to be followed. By way of non-limiting example, the vicinity information may consist of the hardware availability of an output port, an external link or of the adjoining or close-by switch.

The frame is next available to the switching matrix (3) (see FIG. 1), which may be available if the output ports designated by the routing of the frame are ready to receive it, in which case, it receives the frame immediately, or if unavailable, in which case, the frame is retained in the storage memory (45) of the input port.

FIG. 5 shows the incoming digital frame (31, 32, 33, 34) accepted and routed by the addition of a preliminary header (51) designating to the switching matrix (3) the output port or ports that the frame must take.

One advantageous embodiment of this internal routing consists of a parallel word (vector), each bit or group of bits of which corresponding to each output port is set to TRUE so that said output port receives a copy of the digital frame. It is thus easy to route the frame to one, several or all of the output ports. This vector is advantageously stored as it is in the routing table (43), associated with the ID (31) corresponding to this routing behavior.

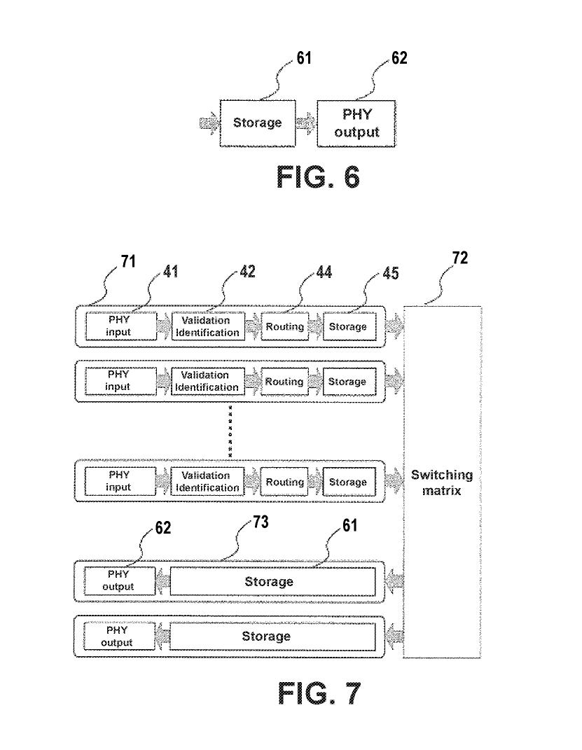

The output port shown in FIG. 6 comprises:
a frame storage memory (61), typically a FIFO that empties to outside as soon as the output is available, the FIFO storage memory (61) optionally being just passed through if the pathway to the outside is available.

The same applies for the storage memory (45) of the input port (FIG. 4), so that a frame can typically pass through the switch in a few internal clock beats necessary to the validation of the ID and to the routing.

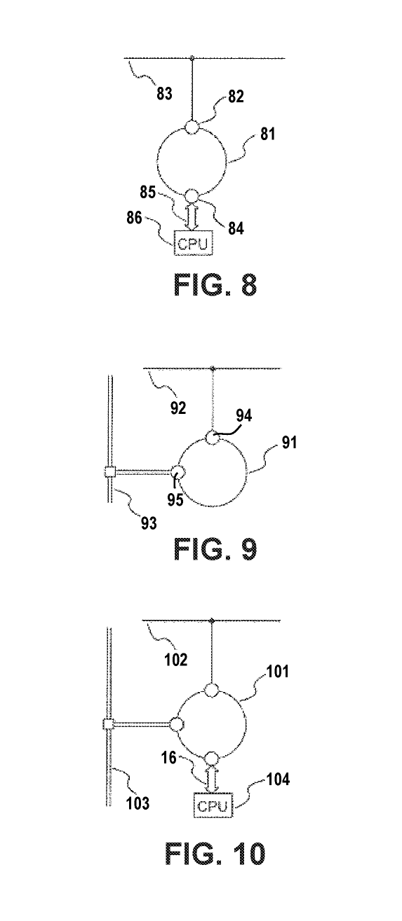

FIG. 8 shows a schematic view of a first example of an application for the use of the switch (81) according to the disclosure for connecting a network (83) via a serial port (82) and a computer (86) by means of a parallel bus (85) via a second port (84). The network interface (41, 62) of the ports is a serializer for the port (82) and a parallel port for second port (84).

In an example of an application illustrated by FIG. 9, the switch (91) according to the disclosure is used as a gateway between a network (93) and a network (92) that are dissimilar, for example, Ethernet 1000BASE-T and 100BASE-T, the physical interfaces of each of the two ports (94, 95) fulfilling the function of the gateway. In the case illustrated, the frames are identical logically and only their baud rate changes.

In the example of an application illustrated by FIG. 10, the switch (101) according to the disclosure is used as a gateway between a network (103) and a network (102) that are physically and logically dissimilar, for example, AFDX and Spacewire, associated with a computer (104) by a parallel port (16).

Logic dissimilarity, corresponding to the complete gateway function, is managed by directing the frames coming from one of the networks to the computer, which converts them to the logic format of the destination network and sends them to it via the switch.

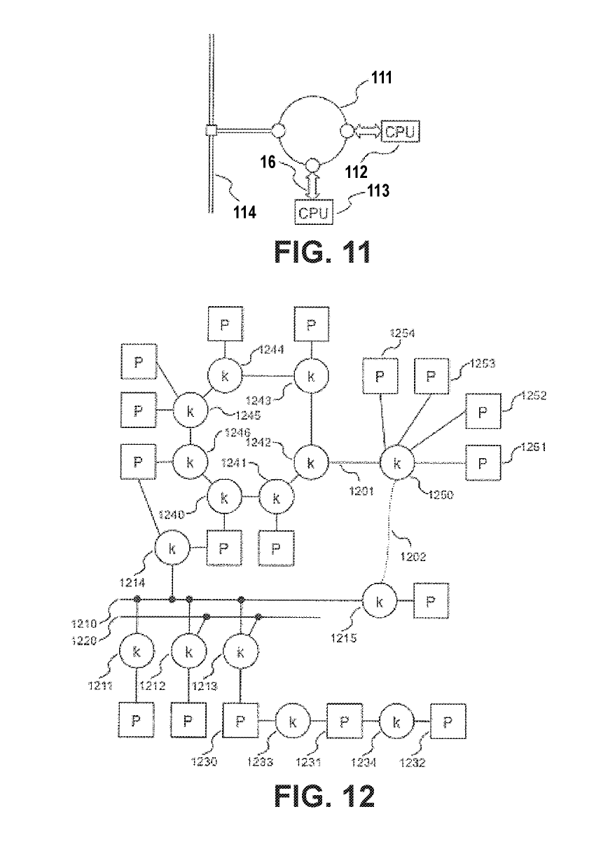

In the example of an application illustrated by FIG. 11, the switch (111) according to the disclosure is used as a coupler between a network (114) and two computers (112, 113).

This arrangement makes it advantageously possible to implement a bi- or multiprocessor structure, in which each has equal access to the network as well as to the other processor or processors. By way of non-limiting example, these structures are advantageous for increasing the computing power at one point in the system, establishing redundancy for logic sources, and promoting exchanges between two computers.

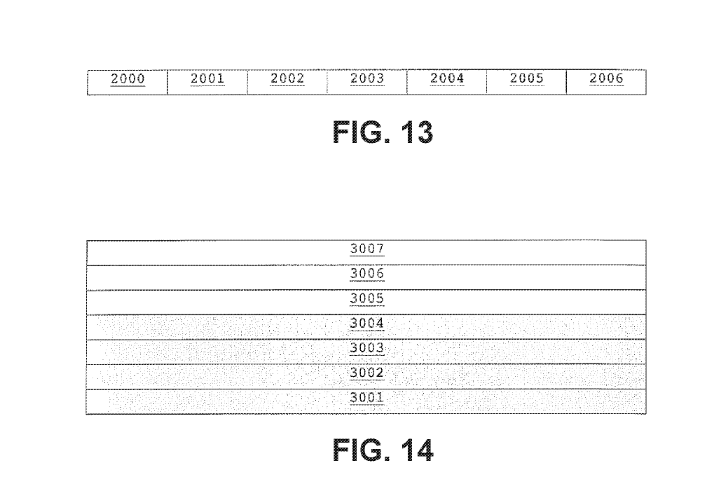

FIG. 12 shows a heterogeneous system physically and logically implemented with switches according to the disclosure, the physical structure of which comprises:
a first subsystem of switches (1211, 1212, 1213, 1214, 1215) implements a bus structure, in which the use of the common medium (1210) in write mode is shared timewise by the associated computers;
a second subsystem comprising two switches (1212, 1213) and a medium (1220) is also arranged in a bus, the switches (1212, 1213) thus sharing two physically separate buses, which constitutes an advantage in terms of availability in the system;
a third system comprising the computers (1230, 1231, 1232) forms a chain by means of couplers (1233, 1234). This arrangement is advantageous for joining, for example, numerous switches with non-critical security with a minimum amount of cabling. If the format of the frames between subsystems is different, the computer (1230) at the start of the chain has the possibility of functioning as a logic gateway in order to exchange the frames in the chain (1230, 1231, 1232) and those of the bus (1210) or (1220);
a fourth subsystem joins in a physical ring the switches (1240 to 1246), where (1240, 1241, 1243, 1244, 1246) are each associated with a computer, (1245) associated with two computers, (1242) serving as a connection to the fifth subsystem.

The ring arrangement is advantageous for closely connecting two computers with a homogeneous pass-band distribution, and offers great intrinsic security in the event of the loss of a link or node.
a fifth subsystem joins four computers (1251, 1252, 1253, 1254) in a star around the switch (1250). Such a structure is advantageous for buses such as AFDX;
the inter system link (1201) between the ring (1240-1246) and the star (1251-1254) affords protection to the system against failure of the switches (1242) and (1250) by opposing the propagation of faults to, respectively, the star and the ring.

The system in FIG. 12 has an obvious weak point through the single connection of the switch (1214) to the bus (1210). It is simple, with the switch according to the disclosure, to overcome this weakness, by way of non-limiting example, by establishing a connection (1202) shown in a dotted line between the switches (1250) and (1215). Splitting of the system thus becomes much less probable, through simultaneous loss of two links.

The purpose of the system using the switch is to route the digital frames between computers. The elements of this service are provided, for example, as follows:
a step of configuring the system of the “total scheduling” type;
all the frames exchanged between the computers are tabulated;
the location of the computers in the geometry of the network is determined;
the most favorable path for each frame and, optionally, the secondary paths in the case of loss of some elements of the system or components of the system are determined;
a table associated with each input port of the switches according to the disclosure is generated, the table being recorded in an associative memory taking as an input the identifier of the frame and delivering as an output its previously scheduled routing vector.

It is advantageous to enable the computer to close the switch to update the flags of the routing table according to algorithms for recognizing the state of the system.

FIG. 13 illustrates an example of a frame structure.

This example of a frame structure corresponds to the frame fields of the Ethernet and IEEE 802.3 networks that are the subject of the following definitions.

a preamble (2000) formed by a binary sequence of alternating 1s and 0s indicating to the addressee that it is an Ethernet or IEEE 802.3 frame. The Ethernet frame comprises an additional byte that is the equivalent of the header field of the IEEE 802.3 frame. Frame header separating character of the IEEE 802.3 network ending in two consecutive 1 bits, which serve to synchronize the reception portions of the frames from all the stations of the local network. The start of the frame is explicitly specified in the Ethernet standard.

The origin (2001) and destination (2002) addresses: the three first bytes of the addresses are attributed by IEEE to the manufacturer. The last three bytes are chosen by the manufacturer of the Ethernet or IEEE 802.3 network card. The source address is always that of a unique addressee (single node). The destination address may be a single address, a multipoint (group) address or a broadcast address (all the nodes).

Information (2003) of the protocol (Ethernet) type that specifies the top-layer protocol that receives the data once the Ethernet processing has ended.

Information (2004) defining the length of the data field (IEEE 802.3) indicting the number of data bytes following this field.

A field sometimes called “payload” (2005) of the data (Ethernet): once the processing of the physical layer and a connecting layer has ended, the data contained in the frame are transmitted to a top-layer protocol specified in the type field. Although Ethernet version 2 does not specify any padding, unlike IEEE 802.3, Ethernet expects to receive at least 46 data bytes. Once the physical layer and connecting layer of processing has ended, the data are transmitted to a top-layer protocol, which must be specified in the data portion of the frame. If the data contained in the frame are insufficient to occupy the 64 bytes that represent the minimum size of the frame, padding bytes are added to the frame.

A frame control sequence (FCS) (2006) containing a cyclic redundancy code (CRC) of 4 bytes, which is created by the sending device and recalculated by the receiving device to ensure that the frame has not been altered en route.

FIG. 14 illustrates the model of the communication stack, for example, in accordance with the OSI (open systems interconnection) model corresponding to ISO 7498.

The OSI model has been designed in layers, so that each layer has a very precise jurisdiction. Every layer communicates only with the layers that are adjacent to it and all the layers are independent of the implementation of the other layers. The aim is to have the possibility of modifying the implementation of one layer without this change affecting the others.

ISO 7498 makes a difference between three concepts that are at the basis of all the layers:
Service: service is a conceptual description of functionalities;
Protocol: the protocol is a set of rules that implement a service;
Interface: the interface is the concrete means of using the service, most of the time a library of functions.

The seven layers that make up the model are generally separated into two groups: the four bottom layers (3000 to 3004) responsible for the communication aspect (they are often implemented by the operating system), and the three top layers (3005 to 3007) responsible for the application aspect (they are often implemented by a library or a specific program).

These layers are as follows:

The program or the user communicates with the application layer (3007), which for its part communicates with the presentation layer (3006), which communicates with the session layer (3005), and so on. The physical layer (3001) communicates with the physical layer on the other side of the tunnel in order to form a communication channel, and then the data go up the layers as far as the application layer (3007), in order to reach the program (and the user) at the other end.

At the bottom of the pyramid is the physical layer (3001). Its role consists of transmitting physical (electrical or optical) signals between two machines. Its service is generally limited to the transmission of a bit or a string of bits, and is able to convert bits into physical signals, and vice versa.

### Examples

### 10Base-T, 100Base-T, Coaxial Cable, Wi-Fi, Bluetooth, Etc.

At the stage just above, the data connection layer (3002) manages communication between two adjacent machines connected by any physical medium. Therefore, here it is possible to transmit a frame from one apparatus to another in the same LAN (local area network). There is no possibility of leaving the local network and, therefore, no need for routing (which will be managed higher up). In fact, the addressing used by the data connection layer 3002 is a physical addressing (like the MAC addresses), making it impossible to detect a network or a subnetwork.

The data connection layer (3002) receives packets from the layer (3003) in order to organize frames, transmitted to the physical layer (3001), which can install means for detecting and correcting transmission errors.

A frame from the data connection layer (3002) contains a header, a destination address, a source address, data, and a “postamble” (normally referred to as a trailer).

### Ethernet, Frame Relay, PPP (Point-to-Point Protocol), Token Ring, Serial Communications.

The network layer (3003) transmits its packets from one computer to another according to the topology of the network and uses routable hierarchical addressing, unlike the layer (3002). It is responsible for sending packets from the source to the destination. The disclosure relates precisely to the switch providing transport of the frames from the layer (3002).

The network layer (3003) provides the routing (finds a path for delivering packets from one place to another through a network), relaying (sending packets to a router that can route them to the destination) and flow control (controlling congestion on the network by switching the packets intelligently).

All the machines in a network must implement the network layer (3003) and the bottom layers (3001 and 3002) in order to be able to communicate. Routers often implement nothing above the network layer (3003), the top layers (3004 to 3007) being useful only to the equipment at the ends.

A network packet also contains a header and source and destination addresses, but this time these are network addresses.

The network layer (3002) does not necessarily perform an error check and some packets may very well arrive out of order, or never arrive, and the sender will not be informed of this. This is a problem that the disclosure makes is possible to solve, by not allowing, unlike the prior art, the possibility of an arrival “out of order,” by proposing a solution guaranteeing the absence of introduction of such “disorder” during transmission. On the other hand, the prior art U.S. Publication No. 2010/0061241 proposes a functioning necessarily introducing such “disorder” since it makes provision for, in some cases, suspending queues, and, therefore, reversing the temporal order of the frames that it propagates.

### IP (the Best Known!), IPX, IPSec.

The transport layer is responsible for providing a virtual communication channel between two points. It in no way concerns itself with the way in which the data will ultimately reach the destination (this is the role of the layer (3003). The layer (3004) is there to guarantee that all the data will go from one point to another, in the required order, without error or redundancy. It is, therefore, here that the error check methods will usually be implemented. The exact methods used will vary from one implementation to another, and there exist five types of transport protocol, each with its degree of correction: of type TPO (which corrects almost nothing and relies on the fact that the network is perfect), to type TP4 (which has extensive error correction and assumes that the network is not reliable such as the internet).

The layer (3004) manipulates messages (sometimes referred to as segments or datagrams) and sends them to their destination, providing an interface that sees the communication as a stream of bytes of variable size according to requirements.

The layer (3004) also brings the concept of ports, which are in the end nothing other than ways of addressing multiple entities situated at the same point in the network. The ports are, therefore, added to the addresses from this layer.

### TCP (Obviously), UDP (Much Less Reliable).

The session layer (3005) provides the mechanisms necessary for the opening, management and closure of a communication session between two processes. It allows authentication, management of positions and session restoration in cases of loss of communication. It is it that allows the creation of a “virtual tunnel” between two distant processes. This tunnel can be used in full duplex, half duplex or simplex, according to the implementation.

When the communication is open and the data begin to arrive, it relays the whole of the layer 3004 for transport proper. The transport of data in no way concerns the session layer. All that matters for it is the question of the channel in which the data will pass.

In the TCP/IP world, these functionalities are, in fact, encapsulated in the layer 3004 (TCP) or left to the care of the application layer. This is because TCP/IP does not entirely comply with the OSI model and takes a few liberties.

### NetBIOS, RPC (Remote Procedure Call, a Protocol Used by WINDOWS® for Many Remote-Access Services), SSH.

The presentation layer (3006) takes care of the “formatting.” It is it that ensures that the data of the application layer (3007) will be converted suitably into a format that can be understood by the other party. It will take care of character representation formats (EBCDIC to ASCII, for example), the representation of the text chains, encryption and decryption, etc.

This layer is in no way concerned with packets, datagrams or connections. It merely converts data in order to ensure that they will be understood correctly, and then sends them to the session layer (3005). In the TCP/IP world, the presentation layer is merged with the application layer, which takes care of a little of all that at the same time. This is the case, for example, with HTTP, which is an application layer protocol (3007) but which is capable of recognizing and converting the encoding of characters.

### ASCII, EBCDIC (Extended Binary Coded Decimal Interchange Code), RDP (Remote Desktop Protocol).

The application layer (3007) is the one that is used by the user. It is in this layer that all the user functionalities are implemented: the commands allow management of the communication, the virtual material, the determination of the available resources, the availability of the communication partners, etc.

### HTTP, FTP, SMTP, POP3, Telnet, BitTorrent DHCP, DNS, etc.

This disclosure relates to the functioning and specificities of the communication layers (3001 to 3003) only, whereas the solution of U.S. Publication No. 2010/0061241 on the other hand relates to the functioning of the top transport communication layer (3004).

1. A switch for facilitating exchange of digital frames with an external computer system and functioning according to a first-in-first-out (FIFO) mode, the switch comprising:
a switching matrix;
at least one input port connected to the switching matrix and configured to:
validate an incoming frame;
route said validated frame; and
temporarily store the validated frame in a non-transitory storage memory based on state information of the switch; and
at least one output port connected to the switching matrix and configured to output an outgoing frame corresponding to the validated frame based on state information of an external computer system.

2. The switch of claim 1, wherein the incoming frame matches the outgoing frame.

3. The switch of claim 1, wherein one or more of the at least one input port and the at least one output port comprises a physical network interface.

4. The switch of claim 1, wherein one or more of the at least one input port and at least one output port is connected to a local computer.

5. The switch of claim 1, further comprising a plurality of computers.

6. The switch of claim 1, wherein one or more of the at least one input port and the at least one output port comprises a serial physical interface.

7. The switch of claim 1, wherein one or more of the at least one input port and the at least one output port comprises a parallel physical interface.

8. The switch of claim 1, wherein the at least one input port and the at least one output port comprise a single input port and a single output port forming a bidirectional communication channel.

9. The switch of claim 1, further comprising a non-transitory storage memory configured to store digital information, the digital information comprising frame validation rules and routing rules applicable to each frame.

10. The switch of claim 9, wherein the routing rules comprise one or more routing paths from the at least one input port to the at least one output port.

11. The switch of claim 10, wherein the routing rules comprise a routing table configured to update based on one or more of the state information of the external computer system and the state information of the switch.

12. The switch of claim 1, wherein the incoming frame is a digital frame.

13. The switch of claim 12, wherein the digital frame comprises:
a frame identifier;
one or more data integrity checks; and
a payload.

14. The switch of claim 1, further comprising a first physical interface configured to convert the incoming frame into a format compatible with FIFO operation.

15. The switch of claim 1, wherein the switching matrix is a computer system.

16. A method of exchanging digital frames, the method comprising:
validating an incoming frame at an input port, the incoming frame comprising an identification key and a payload;
assigning the validated frame a routing vector based on the identification key; and
routing the validated frame to an output port based on the routing vector and state information of the switch, including temporarily storing the validated frame at the input port if the state information indicates that the output port is not available.

17. The method of claim 16, further comprising temporarily storing the validated frame at the output port if vicinity information indicates one or more devices in the vicinity of the output port are not available.

18. The method of claim 16, further comprising converting the incoming frame into a format compatible with first-in-first-out (FIFO) operation.

19. The method of claim 16, wherein routing the validated frame to an output port comprises maintaining the temporal integrity of the validated frame with regard to at least one different incoming frame.

20. A system for exchanging a plurality of digital frames for which temporal integrity among the plurality of digital frames is maintained, the system comprising:
a network interface;
an external device; and
a digital switch connected to the network interface and the external device, the digital switch comprising:
an input port configured to receive the plurality of digital frames from the network interface, validate the plurality of digital frames, assign to each of the plurality of digital frames one or more routing paths to the device, and initiate routing of the plurality of digital frames based on a status of the digital switch; and
an output port configured to receive the plurality of digital frames and initiate output of the plurality of digital frames based on the status of the device.
